(19) United States
(12) Patent Application Publication
(10) Pub. No.: US 2003/0043026 A1
(43) Pub. Date: Mar. 6, 2003

(54) Container for pills with alarm, and methods

(76) Inventors: Terrance O. Noble, Burnsville, MN (US); Robert N. Priebe, Bloomington, MN (US)

Correspondence Address: MERCHANT & GOULD PC, P.O. BOX 2903, MINNEAPOLIS, MN, 55402-0903, US

(21) Appl. No.: 09/945,496

(22) Filed: Aug. 30, 2001

(51) Int. Cl. G08B 1/00

(52) U.S. Cl. 340/309.15; 368/109

(57) ABSTRACT

A construction for holding medication includes a container with at least one compartment having a storage interior and a control device held by the container. The control device includes a timer and an alarm construction. The time activates the alarm construction at a select time interval. The timer includes a rotatable dial, in which the rotatable dial is selectively movable to indicate the selected time interval. The container includes a surrounding side wall and a base. The wall is secured to the base that is spaced no more than a few millimeters from the base to define a storage groove therebetween. The storage groove may contain a sheet of paper with medication identification and instructions.

### TECHNICAL FIELD

This disclosure relates to containers for medication. In particular, this disclosure relates to containers for medication having alarm devices and methods for use.

### BACKGROUND

Many medications are recommended by physicians to have periodic administration at specified times. The objective is to keep a certain level of the medication within the patient's bloodstream. If the patient repeats the doses too frequently, an overdose may result. On the other hand, if the patient doesn't take the medication at the proper time intervals, the concentration of the medication in the patient's bloodstream may become too low to be effective.

While there exists medication containers that include timing devices, many such devices are so complex that many patients are unable to operate it. Improvements in medication containers with alarms are desirable.

### SUMMARY OF THE DISCLOSURE

In one aspect, a construction for holding medication includes a container having at least one compartment defining a storage interior, and a control device held by the container. The control device includes a timer and an alarm construction. The timer is constructed and arranged to actuate the alarm construction at a selected time interval. In preferred embodiments, the timer includes a rotatable dial, which is selectively movable to indicate the selected time interval.

In another aspect, the disclosure is directed to a construction for holding medication that includes a container with at least one compartment. The container includes a surrounding side wall, a base, and a wall secured to the base. The wall is spaced no more than five millimeters from the base to define a storage groove therebetween. In preferred embodiments, the storage groove is sized to receive a sheet of paper that is usable to record patient and medication information.

In another aspect, the disclosure is directed to a method for alerting a person to use medication. The method includes storing medication in a container; rotating a dial in a timer to a selected time interval, the timer being held by the container; and activating an alarm construction held by the container after the selected time interval has elapsed.

In another aspect, the disclosure is directed to a method for storing a sheet of printed indicia in a medication container. The method includes providing a container including at least one storage compartment that has a selectively movable lid, a base, and a wall secured to and projecting from the base. The method further includes moving the lid to access an interior of the storage compartment; placing medication in the interior of the storage compartment; moving the lid to close the storage compartment; and inserting a sheet of printed indicia into a slot between the wall and the base.

### BRIEF DESCRIPTION OF THE DRAWINGS

FIG. 1 is a top plan view of one embodiment of a medication container, constructed according to principles of this disclosure.

FIG. 2 is a bottom plan view of the medication container depicted in FIG. 1.

FIG. 3 is a front elevational view of the medication container depicted in FIG. 1.

FIG. 4 is a rear elevational view of the medication container depicted in FIG. 1.

FIG. 5 is a left end elevational view of the medication container depicted in FIG. 1.

FIG. 6 is a right end elevational view of the medication container depicted in FIG. 1.

FIG. 7 is a schematic end elevational view of the medication container depicted in FIGS. 1-6, and depicting the container without a locking engagement member installed therein.

FIG. 8 is an end elevational view of the medication container depicted in FIG. 7, and showing a lid of the container partially moved from a remaining portion of the container.

FIG. 9 is an end elevational view of the medication container depicted in FIGS. 7 and 8, and showing the lid in an extended position away from a remaining portion of the medication container.

FIG. 10 is a perspective, fragmented view of the medication container depicted in FIGS. 1-9, and showing, in particular, a control device with a dial positioned at the “one o'clock” position.

FIG. 11 is a perspective, fragmented view similar to the view depicted in FIG. 10, and showing the control device with the dial in the “nine o'clock” position.

FIG. 12 is a bottom plan view of the medication container, identical to the view shown in FIG. 2, and also showing a sheet of paper with printed indicia installed between a wall and a base of the medication container.

FIG. 13 is a perspective, fragmented view of the medication container, showing a portion of the wall pivoted away from the base of the medication container.

FIG. 14 is a front elevational, fragmented view depicting a locking feature of the medication container.

FIG. 15 is a view similar to FIG. 14, and showing the medication container in an unlocked position.

FIG. 16 is a flow chart depicting one method for using the control device of the medication container of FIGS. 1-11.

### DETAILED DESCRIPTION

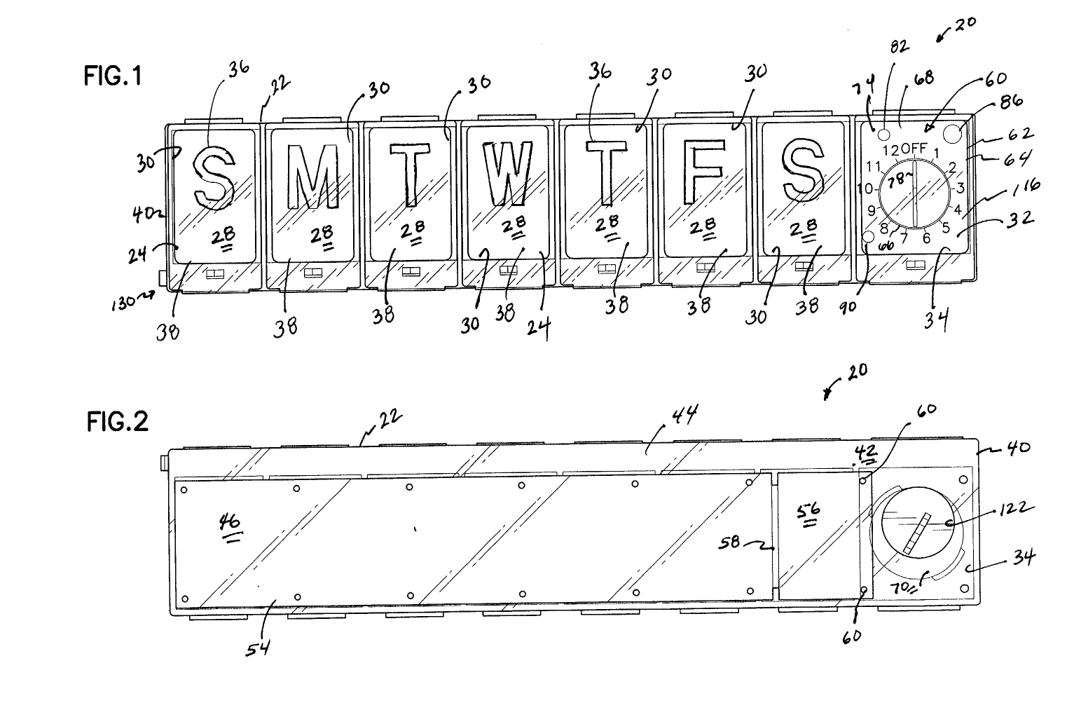

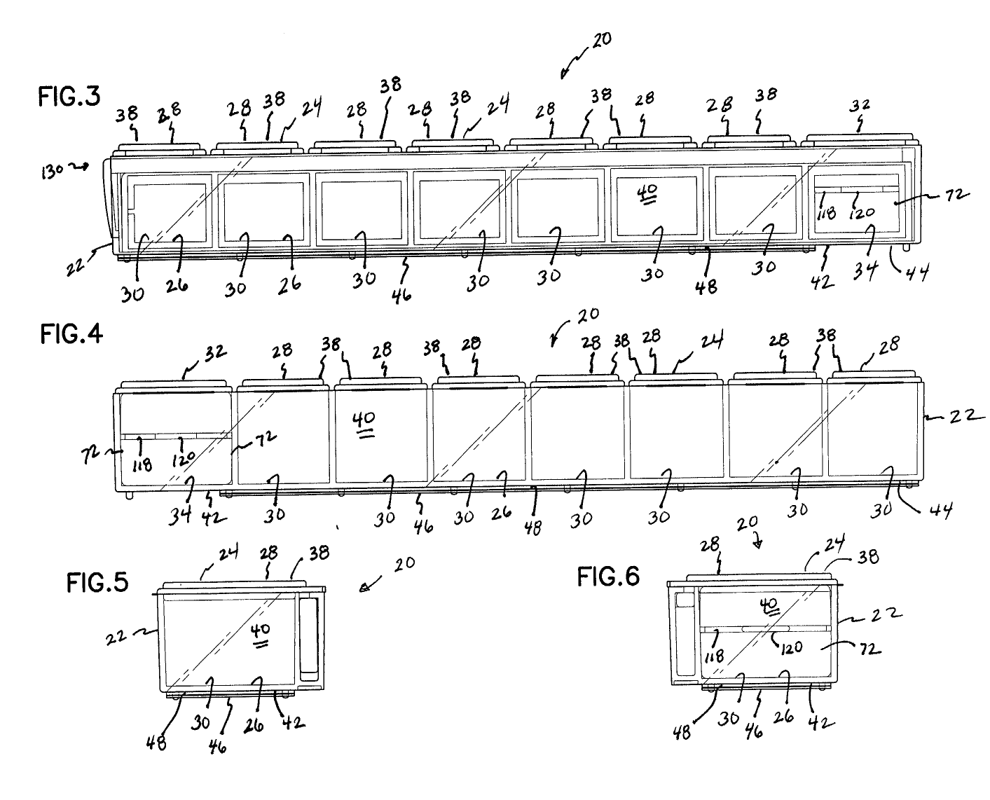

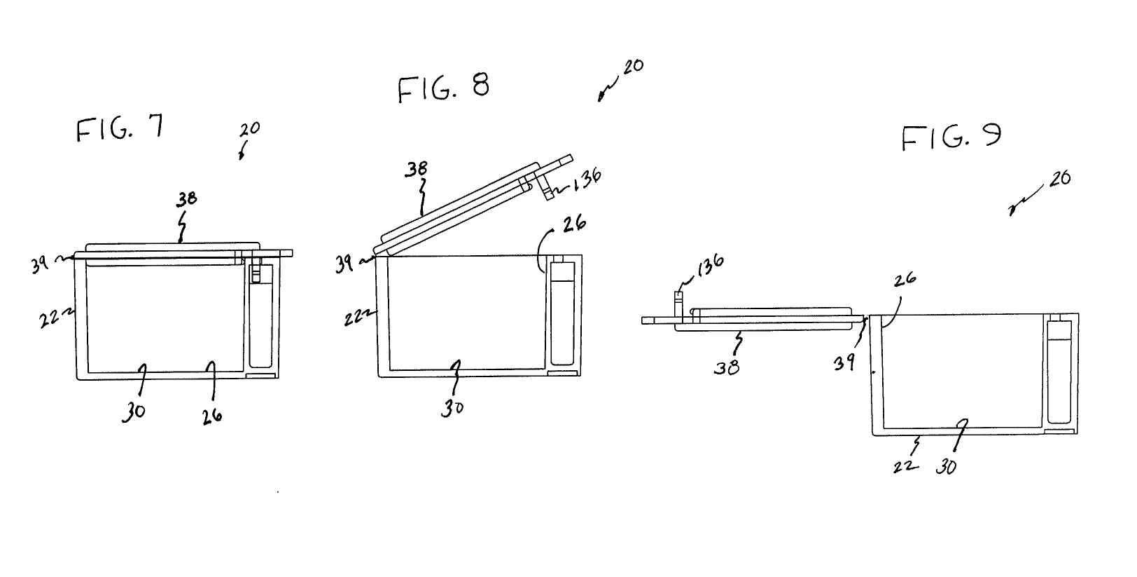

FIGS. 1-6 depict a top plan, bottom plan, front elevational, rear elevational, left and right end views of a pill container or medication construction 20. The construction 20 comprises a container 22 that includes at least one compartment 24 having a storage interior 26. In preferred embodiments, the container 22 includes at least seven compartments 28, each having a storage interior 30 and an additional compartment 32, also having a storage interior 34. In the preferred embodiment illustrated, each of the seven compartments 30 are correlated to one of the days of the week, through the use of indicia 36 appearing on a selectively movable lid 38 hingedly secured thereto at hinges 39 (FIGS. 7-9). Each of the seven compartments 32 includes its own selectively movable lid 38 to provide access to the storage interior 30. In use, a person may find it convenient to store pills, medication, vitamins or other types of things within compartments 32. The indicia 36 are labeled to represent the first letter of each day of the week, in daily order.

In the preferred embodiment illustrated, the container 22 includes a surrounding side wall 40 and a base 42. The base 42 also forms a bottom 44 of the container 22. The side wall 40 and the base 42 define the storage interior 30 of each of the compartments 28. Each of the lids 38 is disposed on an opposite side of the side wall 40 from the base 42. In preferred embodiments, secured to the base 42 is a wall 46 that projects from the base 42 and is spaced no more than five millimeters from the base 42 to define a storage groove 48 therebetween. In preferred embodiments, the wall 46 is spaced no farther from the base 42 than just far enough to accommodate and receive a slip of paper 50. In preferred embodiments, this spacing between the base 42 and the wall 46 defines a depth of the storage groove 48, such that the depth is no greater than 2 millimeters.

The paper 50 preferably includes printed indicia 52 thereon, which can include many types of information. In preferred embodiments, the indicia 52 identifies a name, telephone number, doctor's name and phone number, identification of medication, dosage, color of medication, condition the medication is treating and any directions. The wall 46 thus functions as a holder 54, which keeps the paper 50 having the medication instructions safe and clean.

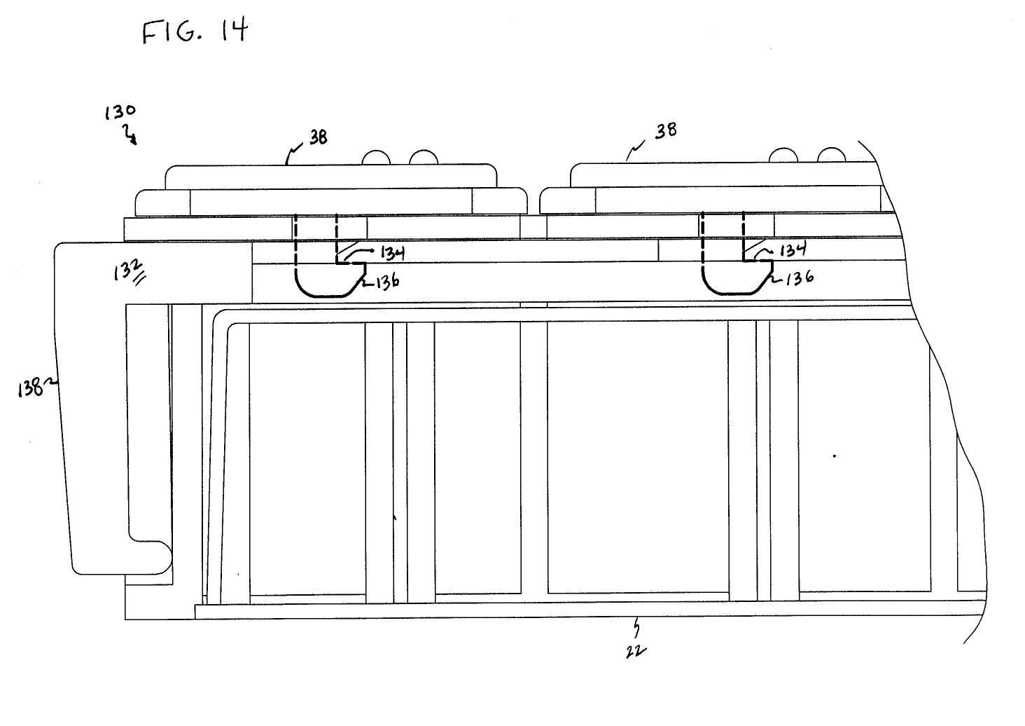

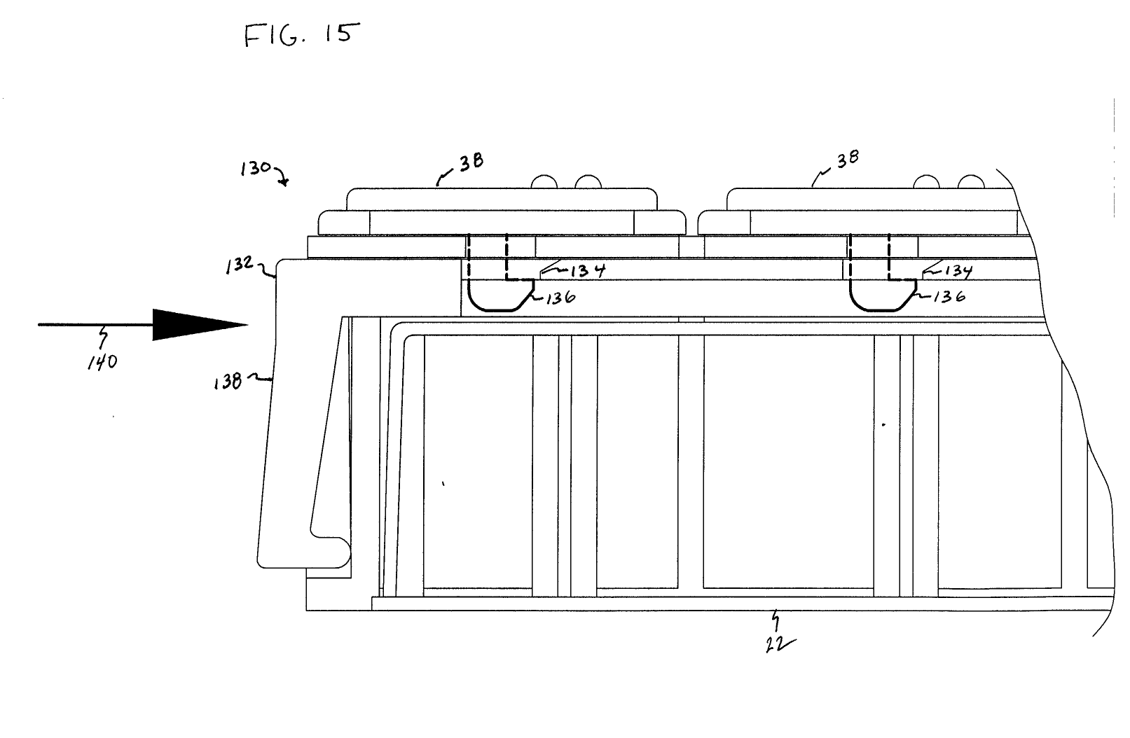

In certain preferred embodiments, the wall 46 includes an access door 56 providing access to the storage groove 48. In preferred embodiments, the access door 56 is hingedly attached to a remaining portion of the wall 46 at a living hinge 58. As such, the access door 56 can be pivoted in a direction away from the bottom 44 to provide access to the groove 48 holding the instruction paper 50. The paper 50 can be removed from the storage groove 48 and the holder 54 by sliding it from the groove 48. The instruction paper 50 may be modified or replaced completely with a new instruction paper 50 and slid back into the groove 48. After replacement, the holder 54 can be closed by pivoting the access door 56 in a direction back toward the base 42 along the hinge 58. Snaps 60 in the form of, for examples, protrusions 61 and apertures 63, allow the access door 56 to be selectively secured to the base 42, until it is desired to access the paper 50 again (FIG. 13).

The container 22 holds a control device 60. Preferably, the control device 60 is held by and contained within the storage interior 34 of the compartment 32. In preferred embodiments, the control device 60 includes a timer 62 and an alarm construction 64. In preferred embodiments, the timer 62 is constructed and arranged to activate or actuate the alarm construction 64 at a selected time interval, a time interval that is selected by the user.

In reference now to FIGS. 1, 10 and 11, a preferred embodiment of the timer is illustrated. Preferably, the timer 62 requires little skill in setting. Preferably, the timer 62 includes a rotatable dial 66. The dial 66 is preferably rotatable and is selectively movable to indicate the selected time interval. In preferred embodiments, the dial 66 is rotatable and can be set at 12 different intervals. The timer 62, in the preferred embodiment illustrated, is generally box-shaped, having a display face 68, a bottom 70 (FIG. 2) opposite of the display face, and four side walls 72 joining the display face 68 and the bottom 70.

In the particular preferred embodiment illustrated, the display face 68 resembles a clock face 74 with the dial 66 being centered within the clock face 74. In preferred embodiments, the clock face 74 includes indicia 76, such as integers 1-12. In the preferred embodiment, the dial 66 includes a pointer 78 that points to the integer 76 that has been selected by rotation of the dial 66 within the clock face 74.

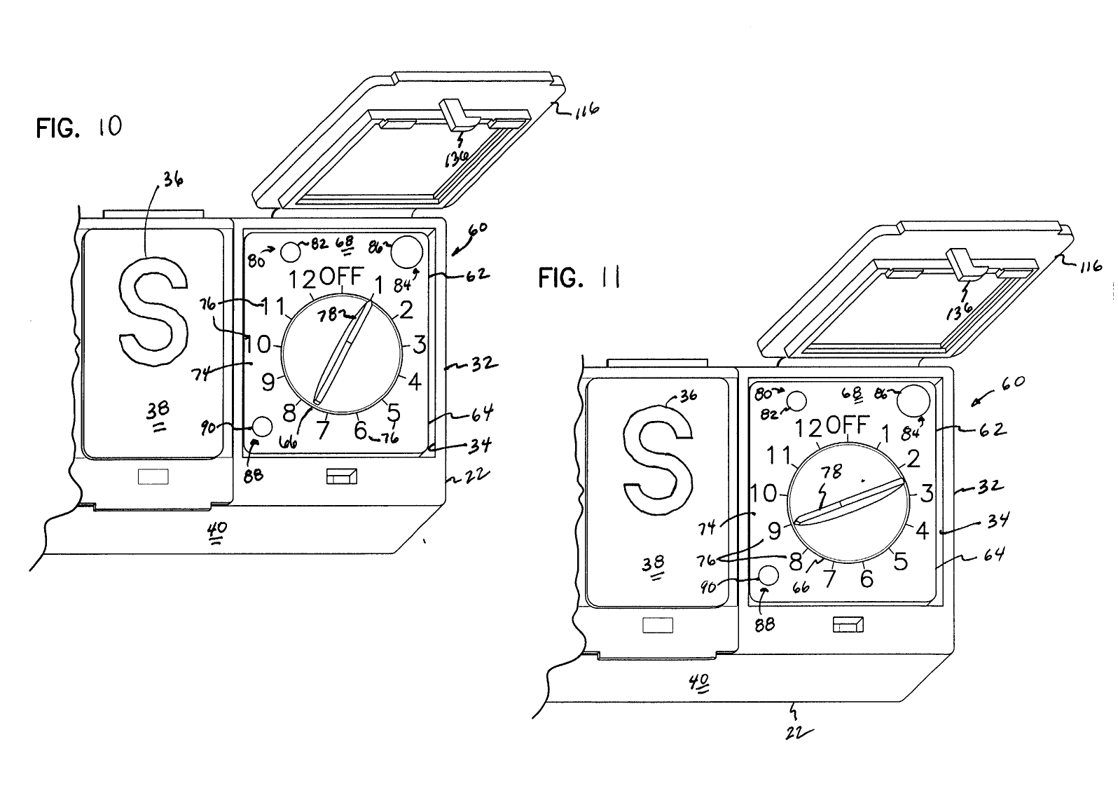

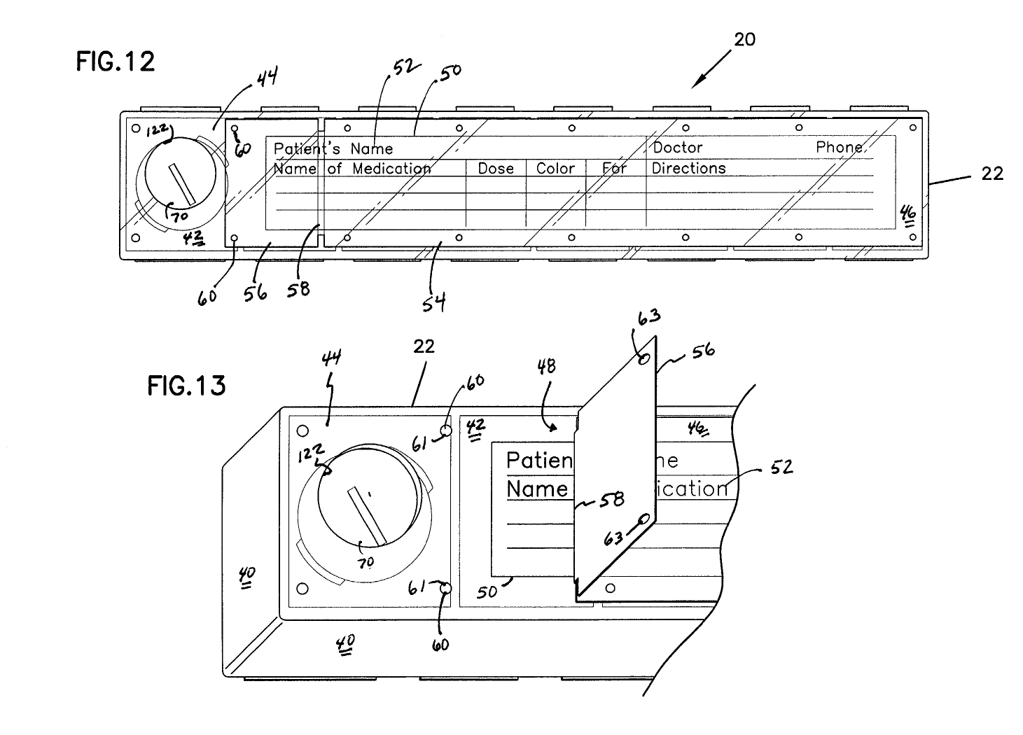

For example, attention is directed to FIG. 1. In FIG. 1, the pointer 78 is pointing to the “off” position. In this setting, the timer 62 is not activated. In FIG. 10, the control device 60 is shown with the dial 66 having been rotated from the “off” position to the one o'clock position. The pointer 78 is pointing to the integer “1”. In this setting, the timer 62 is activated with a selected time interval being the time interval that corresponds to the position with the dial 66 in the one o'clock position. In one example embodiment, the one o'clock position will correspond to a time interval of one hour. Of course, it should be understood, that the timer 62 can accommodate the appropriate circuitry to have this time interval be something other than one hour. In FIG. 11, the dial 66 has been rotated to the nine o'clock position. It can be seen that the pointer 78 is pointing to the integer “9”. In one embodiment, this would indicate that the selected time interval is 9 hours. Again, the timer 62 can be modified such that the nine o'clock position corresponds to other time intervals. In preferred embodiments, once the dial 66 is rotated to indicate the selected time interval, the dial 66 remains fixed in this position until the user rotates the dial 66 to some other position (such as “off” to deactivate the timer 62, or to some other position on the clock face 74 to change the time interval).

In preferred embodiments, the timer 62 is constructed and arranged to repeat activating the alarm construction 64 at the selected time interval. In particular, the timer 62 includes appropriate circuitry such that it will activate the alarm 64 for the period set by the dial 66. That is, for example, in FIG. 10, the dial 66 has indicated a time interval corresponding to the one o'clock position. In preferred embodiments, the one o'clock position corresponds to a one-hour time interval. In this case, the alarm construction 64 will be activated by the timer 62 every one hour. In FIG. 11, the alarm construction 64 will be activated every nine hours.

Preferably, the alarm construction 64 includes a first visual signal 80. Also, in preferred embodiments, the alarm construction 64 includes an audio signal. In preferred embodiments, the first visual signal 80 is a red, blinking light 82, while the audio signal is in the form of a beep. It should be understood that a number of different types of visual and audio signals are usable.

Preferably, the audio signal, upon expiration of the selected time interval, will give a number of beeps in short duration, followed by a short interval of silence, and then repeat the number of beeps in short duration. Preferably, this pattern is repeated continuously for about one minute. After about one minute, the audio signal will not sound. Preferably, there will be five quick beeps, followed by a short interval, and then the five quick beeps are repeated. This is continued for approximately one minute, and then the audio signal stops. In addition, in preferred embodiments, the red light 82 will flash or blink in unison with the beeps of the audio signal.

In preferred embodiments, the alarm construction 64 further includes a reset mechanism 84. The reset mechanism 84 is shown in this embodiment as a button 86. The reset button 86 is manipulated, such as by pushing, in order to deactivate the first visual signal 80. In addition, if the audio signal is also sounding, the reset mechanism 84 will deactivate the audio signal. In this manner, the red light 82 will continue to flash until the reset mechanism 84 is pressed. In use, for example, after expiration of the selected time interval, the audio signal will sound and the light 82 will blink. If the patient does not hear the audio signal or if they are away at the time of activation, when they return, they will see the red blinking light 82 and know that the time had come to take the medication in the compartment 28. By pressing the reset button 86, the red blinking light 82 is shut off. The timer 62, however, has reset itself automatically once the time interval expired. Thus, the alarm construction 64 is not dependent upon the user to accurately set the timer 62. This is an improvement with some timers in the prior art in that some prior art timers react to the time that the medication was taken instead of when it should have been taken.

In preferred embodiments, the alarm construction 64 includes a second visual signal 88. The second visual signal 88 is depicted in the preferred embodiment as a blinking light 90, and in one embodiment, it is a green blinking light 90. The second visual signal 88 is activated in response to the setting of the selected time interval. In particular, the second visual signal 88 is actuated in response to rotation of the dial 66. The second visual signal 88 provides information to the user that the control device 60 is active, and has had the time interval set. Further, the second visual signal 88 indicates that the timer 62 is actively counting down the period until the alarm construction 64 in the form of the first visual signal 80 and the audio signal is activated. In many preferred embodiments, there is further a second audio signal that is activated when the dial 66 is rotated. This second audio signal may be in the form of a very short beep or squeak, to inform the user that the control device 60 has been activated.

Attention is directed to FIG. 16. A method of using the control device 60 is shown generally at 100. In use, the time interval is set at 101. This is done by rotating the dial 66 to point the pointer 78 to the selected time interval as represented by the indicia 76 on the clock face 74. By rotating the dial 66, the “on” signal is activated at 102. In the particular embodiment illustrated, the “on” signal corresponds to the second visual signal 88, which, in preferred embodiments, is the blinking green light 90. Further, in preferred embodiments, the “on” signal also corresponds to an audio signal, in the form of a quick squeal or beep.

Next, after the time interval is set at 101, which activates the on signal 102, a clock is started at 103. This starts to count down the time interval that has been selected at step 101. The clock is run at 104, and it is checked for whether the selected time interval has expired at step 105. If the time interval has not run its full course, the clock continues to run at step 104. Once the time interval has completely run, the alarm signal is activated at step 106. Also, after the interval period has expired, not only is the step of activating the alarm signal 106 carried out, but also the step of starting the clock 103 is repeated. By starting the clock 103, the time interval again begins to run its course.

At step 107, a check is made to see whether the reset mechanism 84 has been actuated. In the particular embodiment illustrated, if the reset button 86 has not been pushed, then the step of activating the alarm signal 106 continues. As described above, in preferred embodiments, this alarm signal is in the form of red blinking light 82 and, for about a minute, an audio signal as well.

If the reset button 86 has been pushed, the alarm signal is deactivated. For example, in the preferred embodiment, the red blinking light 82 is deactivated, such that it is no longer lit up nor blinks.

One example of use is as follows: suppose a patient is supposed to take his medication every eight hours. The time interval would be set to eight hours by rotating the dial 66 to the eight o'clock position, such that the pointer 78 points to the integer “8”. Setting the time interval will cause the second visual signal 88 to activate, but lighting up the blinking light 90. Further, the second audio signal will emit a beep or a squeak. After expiration of eight hours, the first visual signal 80 and the audio signal will activate. In preferred embodiments, the red light 82 will light up and blink, and will flash in unison with the emission of the audio signal in the form of beeps. The audio signal will beep five times, rest for a short period, beep five times, rest, and continue this pattern for up to one minute. The patient notices the red blinking light 82, presses the reset button 86, and takes his medication. After the expiration of the first eight hours, the timer 62 has begun to count down the next eight hours. Suppose, for example, the next eight hours will expire at 3:00 p.m. At 3:00 p.m., the red light 82 will again blink, along with the audio signal. Suppose, the patient was away and returns at 5:00 p.m. At 5:00 p.m., the patient notices that the visual signal 80 is activated (that is, the red light 82 is flashing). In cases like this, many physicians advise that the patient take their medication as soon as they remember it, and take their next scheduled dosage when it is supposed to be taken. The patient takes his medication, then, at 5:00 p.m., and hits the reset mechanism 84 in order to stop the light 82 from flashing red. The timer 62 has already reset itself, and will activate the alarm 64 at eight hours from 3:00 p.m. (11:00 p.m.). This example demonstrates how the timer 62 automatically resets for the selected time interval. This is an advantage over certain prior art constructions, where timers will not begin to count down for the next time interval until the patient manually resets the timer.

In the preferred embodiment illustrated, the control device 60 is held within storage interior 34 of the compartment 32. An optional lid 116 selectively covers the storage interior 34 and the control device 60. In many preferred embodiments, the container 62 is constructed of a transparent material, such that the control device 60 can be viewed through the lid 116.

Preferably, the control device 60 includes a groove 118 in the side walls 72 (FIG. 6) that engages a protrusion 120 extending from the side wall 40 lining the storage interior 34. This protrusion 120 engaging the groove 118 helps to hold the control device 60 within the compartment 32.

In the preferred embodiment illustrated, the base 42 defines an aperture 122 (FIG. 2) that allows access to the bottom 70 of the control device 60. Thus, when the lid 116 is away from the side wall 40, the control device 60 can be removed from the compartment 32 by pressing the bottom 70 of the control device 60 through the aperture 122 and disengaging the protrusion 120 from the groove 118. This dislodges the control device 60 from the compartment 32 and allows the control device 60 to be completely removed from the compartment 32.

Another feature of the medication construction 20 includes a locking arrangement 130 for the container 22. In preferred embodiments, the locking arrangement 130 is the type of arrangement described in U.S. Pat. No. 6,000,546 assigned to Apothecary Products, Inc., Burnsville, Minn., the assignee of this application. U.S. Pat. No. 6,000,546 is incorporated herein by reference.

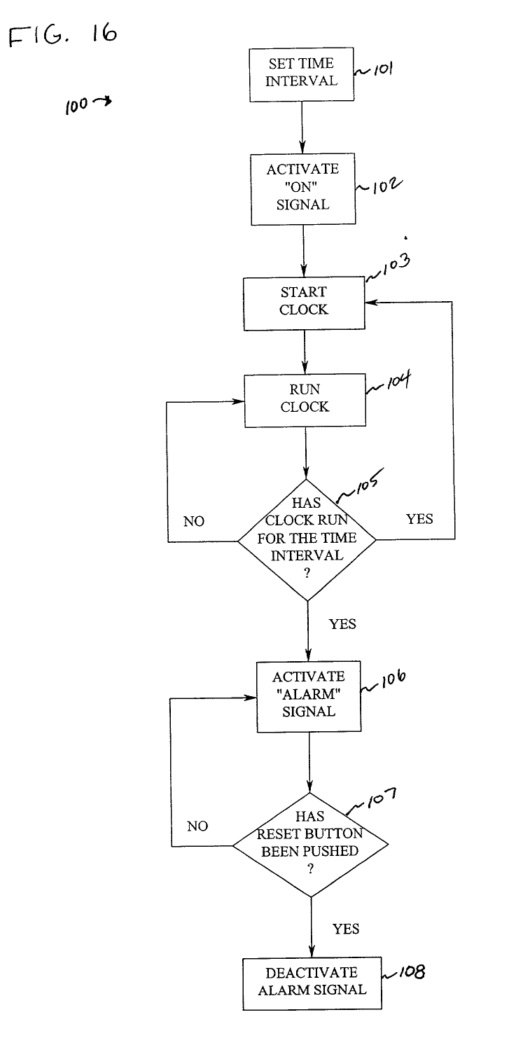

In general, and as shown in FIGS. 14 and 15, the locking arrangement 130 includes an engagement member 132 having a plurality of catches 134. Each of the lids 38 includes a hook 136. The engagement member 132 includes a transverse member 138, preferably manufactured from a resilient material, such that it may be selectively, elastically deformed. By pressing on the transverse member 138, the engagement member 132 moves the catches 134 laterally relative to the hooks 136.

FIG. 14 shows the catches 134 engaged with and holding the hooks 136, such that the lids 38 are held or trapped into a closed position. FIG. 15 shows the transverse member 138 pressed in the direction of arrow 140, which has moved the catches 134 laterally and out of engagement with the hooks 136. This allows the lids 38 to be moved away from the compartments 28.

In the preferred embodiment illustrated, the compartment 32 holding the control device 60 also has a lockable lid 116, lockable in the same fashion as described above.

It should be understood that the medication construction 20 can be used without locking arrangement 130.

It is to be understood that even though numerous characteristics and advantages of the invention have been set forth in the foregoing description, together with details of the structure and function of the invention, the disclosure is illustrative only, and changes may be made in detail, especially in matters of shape, size and arrangement of the parts within the principles of the invention to the full extent indicated by the broad general meeting of the terms in which the appended claims are expressed.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A construction for holding medication; the construction comprising:
(a) a container including at least one compartment defining a storage interior; and
(b) a control device held by said container; said control device including a timer and an alarm construction; said timer constructed and arranged to actuate said alarm construction at a selected time interval;
(i) said timer including a rotatable dial;
(ii) said rotatable dial being selectively movable to indicate said selected time interval.

2. A construction according to claim 1 wherein:
(a) said timer is constructed and arranged to repeat actuating said alarm construction at said selected time interval.

3. A construction according to claim 2 wherein:
(a) said alarm construction includes a first visual signal.

4. A construction according to claim 3 wherein:
(a) said alarm construction further includes an audio signal.

5. A construction according to claim 4 wherein:
(a) said alarm construction includes a second visual signal;
(i) said second visual signal being actuated responsive to rotation of said dial.

6. A construction according to claim 5 wherein:
(a) said alarm construction includes a reset mechanism;
(i) said first visual signal being deactivated responsive to manipulation of said reset mechanism.

7. A construction according to claim 6 wherein:
(a) said container includes at least seven compartments; each of the compartments defining a storage interior and having a selectively movable lid providing access to a respective storage interior.

8. A construction according to claim 6 wherein:
(a) said container includes eight compartments; each of the compartments defining a storage interior;
(i) at least seven of the compartments having a selectively movable lid providing access to a respective storage interior; and
(ii) one of the compartments holding the control device within its respective storage interior.

9. A construction according to claim 1 wherein:
(a) said container further includes a locking mechanism to prevent unintended access to said storage interior.

10. A construction according to claim 1 wherein:
(a) said container includes:
(i) a surrounding sidewall and a base; said sidewall and base defining said storage interior;
(ii) at least one selectively movable lid providing access to said storage interior; and
(iii) a wall secured to said base; said wall being spaced no more than 5 mm from said base to define a storage groove therebetween.

11. A construction according to claim 10 wherein:
(a) a portion of said wall includes an access door; said access door providing access to said storage groove.

12. A construction for holding medication; the construction comprising:
(a) a container including at least one compartment; said container including a surrounding sidewall; and a base; said sidewall and base defining a storage interior; said container including at least one selectively movable lid providing access to said storage interior; and
(b) a wall secured to said base; said wall being spaced no more than 5 mm from said base to define a storage groove therebetween.

13. A construction according to claim 12 wherein:
(a) a portion of said wall includes an access door; said access door providing access to said storage groove; and
(b) said groove includes a depth defined between said base and an inner surface of said wall;
(i) said depth being no greater than 2 mm.

14. A construction according to claim 13 wherein:
(a) said access door is hingedly attached to a remaining portion of said wall.

15. A construction according to claim 13 wherein:
(a) said wall includes a living hinge between said access door and a remaining portion of said wall.

16. A construction according to claim 13 further including:
(a) a sheet of paper selectively slidable in and out of said groove.

17. A construction according to claim 13 further including:
(a) a control device held by said container; said control device including a timer and an alarm construction; said timer constructed and arranged to actuate said alarm construction at a selected time interval;
(i) said timer including a rotatable dial;
(ii) said rotatable dial being selectively movable to indicate said selected time interval.

18. A construction according to claim 17 wherein:
(a) said container includes eight compartments; each of the compartments defining a storage interior;
(i) at least seven of the compartments having a selectively movable lid providing access to a respective storage interior; and
(ii) one of the compartments holding the control device within its respective storage interior.

19. A construction according to claim 18 wherein:
(a) said timer is constructed and arranged to repeat actuating said alarm construction at said selected time interval; and
(b) said alarm construction includes a first visual signal; an audio signal; a second visual signal; and a reset mechanism;
(i) said first visual signal and said audio signal being actuated after said selected time interval has elapsed;
(ii) said second visual signal being actuated responsive to rotation of said dial; and
(iii) said first visual signal being deactivated responsive to manipulation of said reset mechanism.

20. A method for alerting a person to use medication; the method comprising:
(a) storing medication in a container;
(b) rotating a dial in a timer to a selected time interval; the timer being held by the container; and
(c) actuating an alarm construction held by the container after the selected time interval has elapsed.

21. A method according to claim 20 wherein:
(a) said step of actuating includes actuating a first visual signal and an audio signal.

22. A method according to claim 21 wherein:
(a) said step of actuating includes continuously actuating the first visual signal until a reset mechanism on the alarm construction is actuated.

23. A method according to claim 22 further including:
(a) after said step actuating, starting to time the selected time interval again.

24. A method according to claim 22 further including:
(a) after said step of rotating, actuating a second visual signal on the alarm construction.

25. A method according to claim 24 wherein:
(a) said step of storing medication in a container includes:
(i) providing a container including at least seven storage compartments; each of the storage compartments including a respective selectively movable lid;
(ii) selecting one of the storage compartments and moving the lid to provide access to an interior of the selected storage compartment;
(iii) placing medication in the interior of the selected storage compartment; and
(iv) moving the lid to close the selected storage compartment.

26. A method according to claim 25 wherein:
(a) said step of storing medication includes providing a container including at least eight storage compartments; and
(b) said step of rotating a dial in a timer to a selected time interval includes rotating a dial in a timer held within one of the eight storage compartments.

27. A method for storing a sheet of printed indicia in a medication container; the method comprising:
(a) providing a container including at least one storage compartment; the container including a selectively movable lid, a base, and a wall secured to and projecting from the base;
(b) moving the lid to provide access to an interior of the storage compartment;
(c) placing medication in the interior of the storage compartment;
(d) moving the lid to close the storage compartment;
(e) inserting a sheet of printed indicia into a slot between the wall and the base.

28. A method according to claim 27 further including:
(a) before said step of inserting a sheet of printed indicia, pivoting a portion of the wall along a hinge away from the base to provide access to the slot; and
(b) after said step of inserting a sheet of printed indicia, pivoting the portion of the wall along the hinge in a direction toward the base.

29. A method according to claim 28 wherein:
(a) said step of providing a container includes providing a container having at least seven storage compartments; each of the storage compartments including a respective selectively movable lid.

30. A method according to claim 29 further including:
(a) rotating a dial in a timer to a selected time interval; the timer being held by the container; and
(b) actuating an alarm construction held by the container after the selected time interval has elapsed.
